(19) United States
(12) Patent Application Publication
(10) Pub. No.: US 2003/0144959 A1
(43) Pub. Date: Jul. 31, 2003

(54) Access control method, storage apparatus and information processing apparatus

(75) Inventor: Satoshi Makita, Kawasaki (JP)

Correspondence Address: Patrick G. Burns, Esq., GREER, BURNS & CRAIN, LTD., 300 South Wacker Dr., Suite 2500, Chicago, IL, 60606, US

(73) Assignee: FUJITSU LIMITED

(21) Appl. No.: 10/196,591

(22) Filed: Jul. 16, 2002

(30) Foreign Application Priority Data
Jan. 31, 2002 (JP) 2002-024235

(51) Int. Cl. G06F 17/60

(52) U.S. Cl. 705/51

(57) ABSTRACT

An access control method controls access from an information processing apparatus which is connectable to a device requiring a first password authentication to a storage medium which requires a second password authentication. The access control method automatically generates a password based on key information read from the device, when an authentication result of a password input to the information processing apparatus and a first password read from the device is correct, and enables access to the storage medium when an authentication result of the generated password and a second password read from the storage medium is correct.

### BACKGROUND OF THE INVENTION

This application claims the benefit of a Japanese Patent Application No.2002-024235 filed Jan. 31, 2002, in the Japanese Patent Office, the disclosure of which is hereby incorporated by reference.

1. Field of the Invention

The present invention generally relates to access control methods, storage apparatuses and information processing apparatuses, and more particularly to an access control method for controlling access to a storage medium having a security function, and a storage apparatus and an information processing apparatus which employ such an access control method.

2. Description of the Related Art

In this specification, a storage medium having a security function refers to a storage medium which cannot be accessed unless an authentication using a password or the like is made and it is confirmed that a user is a legitimate (or authorized) user. The storage medium itself is not limited to a particular type of media, as long as an information processing apparatus such as a computer can record information on and/or reproduce information from the storage medium. The storage medium may be selected from disk and card-shaped magnetic recording media, optical recording media and magneto-optical recording media, and semiconductor memory devices such as RAMs.

Some personal computers (PCs) have a structure for detachably receiving a so-called PC card. A memory, a processing circuit and the like are mounted on the PC card, and the PC card having a desired function is inserted into the personal computer when using the personal computer to perform a specific process.

In order to prevent unauthorized use of the PC card, a so-called secure PC card has been proposed in which a password is registered in advance to provide a security function. When the secure PC card is inserted into the personal computer, the user inputs to the personal computer the password which enables the use of this secure PC card. The personal computer carries out a password authentication, and if the password input by the user and the registered password of the secure PC card match, it is confirmed that the user is a legitimate user and the use of the secure PC card becomes possible.

On the other hand, in a case where a disk drive is connected to the personal computer, for example, a disk which is loaded into the disk drive may have a security function which enables only a legitimate user to make access to the disk. Such a disk is called a security disk, and a password is registered in advance to prevent unauthorized use of the security disk. When the security disk is loaded into the disk drive, the user inputs to the personal computer the password which enables the use of this security disk. The personal computer carries out a password authentication, and if the password input by the user and the registered password of the security disk match, it is confirmed that the user is a legitimate user and the use of the security disk becomes possible.

Accordingly, when using the secure PC card and the security disk at the same time, the user must input to the computer both the password which enables the use of the secure PC card and the password which enables the use of the security disk.

It is conceivable to use a common password for the password of the secure PC card and the password of the security disk. However, both the secure PC card and the security disk may be used by a plurality of users. In addition, a group of users who use a predetermined secure PC card and a group of users who use a predetermined security disk are not necessarily the same. For this reason, the use of the common password for the password of the secure PC card and the password of the security disk is undesirable because it will deteriorate the security function itself.

Conventionally, when using the secure PC card and the security disk at the same time, the user must input the password which enables the use of the secure PC card and the password which enables the use of the security disk. As a result, there was a problem in that the user must carry out trouble some operations of inputting two passwords, and the load on the user was large. In addition, the user must remember the password of each secure PC card to be used and the password of each security disk to be used or, the passwords of each secure PC card and each security disk must be managed to cope with a situation where the user forgets the passwords. Consequently, there was another problem in that the load on the user is large with regard to the management of the passwords. Furthermore, because it is necessary to carry out the password authentication at least twice when using both the secure PC card and the security disk at the same time, there was also a problem in that the access to the security disk cannot be made in a short time.

As described above, it is conceivable to use the common password for the password of the secure PC card and the password of the security disk. But in this conceivable case, the security function itself deteriorates, and the original purpose of using the secure PC card and the security disk is lost.

### SUMMARY OF THE INVENTION

Accordingly, it is a general object of the present invention to provide a novel and useful access control method, storage apparatus and information processing apparatus, in which the problems described above are eliminated.

Another and more specific object of the present invention is to provide an access control method, storage apparatus and information processing apparatus, which can reduce the load on the user when using both a PC card having a security function and a storage medium having a security function, enable password authentication by a simple operation in a short time, and shorten access time to the storage medium.

Still another object of the present invention is to provide an access control method for controlling access from an information processing apparatus which is connectable to a device requiring a first password authentication to a storage medium which requires a second password authentication, comprising a password generating step which automatically generates a password based on key information read from the device, when an authentication result of a password input to the information processing apparatus and a first password read from the device is correct; and an access control step which enables access to the storage medium when an authentication result of the generated password and a second password read from the storage medium is correct. According to the access control method of the present invention, it is possible to reduce the load on the user when using both the device such as a PC card having a security function and the storage medium having a security function, enable password authentication by a simple operation in a short time, and shorten access time to the storage medium.

A further object of the present invention is to provide a storage apparatus loadable with a storage medium which is accessible from an information processing apparatus which is connectable to a device requiring a first password authentication, where the storage medium requiring a second password authentication, and the storage apparatus comprising a receiving section which receives from the information processing apparatus a password which is generated when an authentication result of a password input to the information processing apparatus and the first password read from the device is correct, and is enciphered using an enciphering key which is generated based on key information from the device and read from the device; and an access control section which enables access from the information processing apparatus to the storage medium when an authentication result of the enciphered password which is deciphered based on an enciphering key read from the storage medium and the second password read from the storage medium is correct. According to storage apparatus of the present invention, is possible to reduce the load on the user when using both the device such as a PC card having a security function and the storage medium having a security function, enable password authentication by a simple operation in a short time, and shorten access time to the storage medium.

Another object of the present invention is to provide an information processing apparatus which is connectable to a device requiring a first password authentication and accesses a storage medium requiring a second password authentication, comprising a password generating section which automatically generates a password based on key information read from the device, when an authentication result of an input password and a first password read from the device is correct; and an access control section which enables access to the storage medium when an authentication result of the generated password and a second password read from the storage medium is correct. According to the information processing apparatus of the present invention, is possible to reduce the load on the user when using both the device such as a PC card having a security function and the storage medium having a security function, enable password authentication by a simple operation in a short time, and shorten access time to the storage medium.

Other objects and further features of the present invention will be apparent from the following detailed description when read in conjunction with the accompanying drawings.

### BRIEF DESCRIPTION OF THE DRAWINGS

FIG. 1 is a diagram showing a system which is applied with a first embodiment of an access control method according to the present invention;

FIG. 2 is a system block diagram showing a structure of an important part of a personal computer;

FIG. 3 is a system block diagram showing a structure of an important part of a disk drive;

FIG. 4 is a diagram showing a structure of a secure PC card;

FIG. 5 is a diagram showing a structure of a storage region on a disk;

FIG. 6 is a flow chart for explaining a password authentication process;

FIG. 7 is a flow chart for explaining a password setting process for the disk;

FIG. 8 is a flow chart for explaining a password authentication process for the disk;

FIG. 9 is a diagram showing a structure of a secure PC card of a second embodiment;

FIG. 10 is a diagram showing a structure of a storage region on a disk of the second embodiment;

FIG. 11 is a flow chart for explaining a password setting process for the disk in the second embodiment; and

FIG. 12 is a flow chart for explaining a password authentication process for the disk in the second embodiment.

### DESCRIPTION OF THE PREFERRED EMBODIMENTS

A description will now be given of embodiments of an access control method according to the present invention, a storage apparatus according to the present invention, and an information processing apparatus according to the present invention, by referring to the drawings.

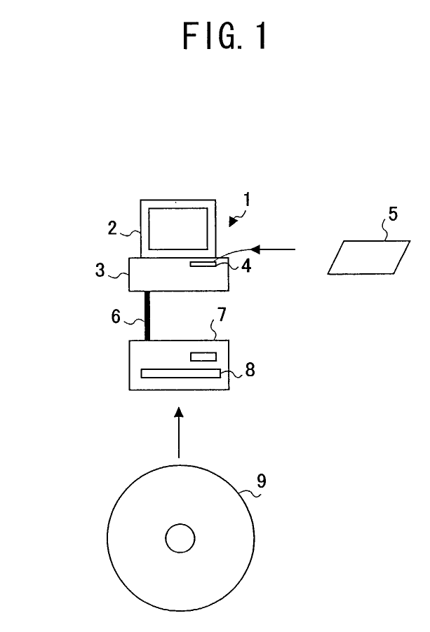

FIG. 1 is a diagram showing a system applied with a first embodiment of the access control method according to the present invention. The system shown in FIG. 1 includes a personal computer 1 and a disk drive 7. The personal computer 7 and the disk drive 7 are connected via a wire and/or wireless connecting means 6. The connecting means 6 may be formed by a cable and/or radio network.

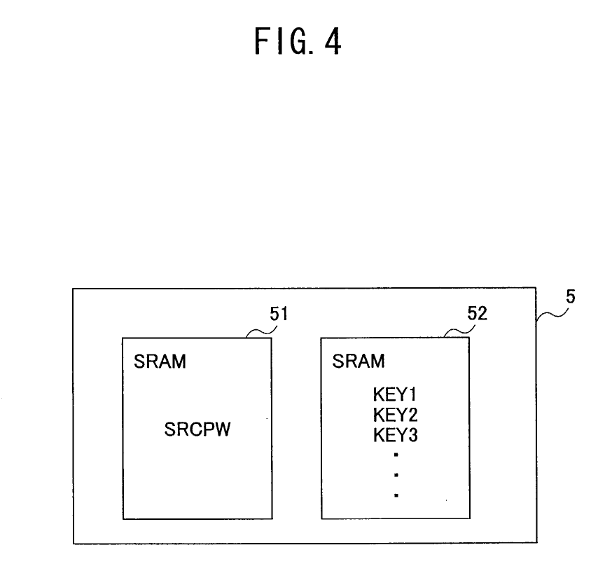

The personal computer 1 includes a display 2 and a main body 3. The main body 3 is provided with a PC card connecting section 4 to which a secure PC card 5 is detachably inserted and connected. The personal computer 1 forms a first embodiment of the information processing apparatus according to the present invention. The secure PC card 5 will be described later in conjunction with FIG. 4.

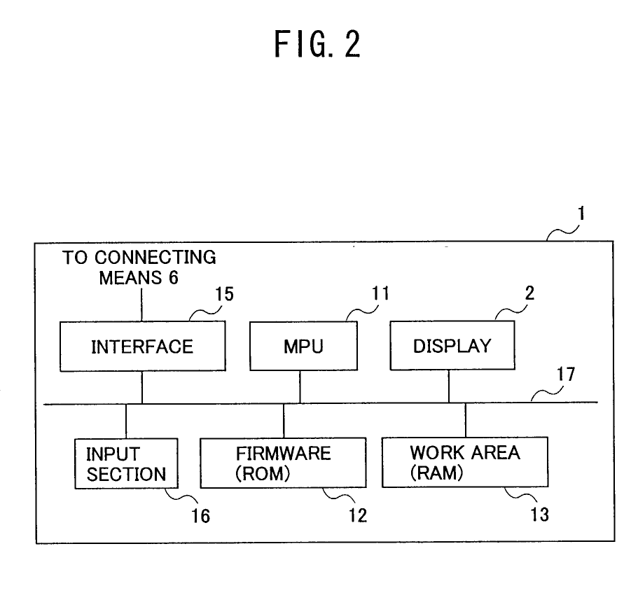

FIG. 2 is a system block diagram showing a structure of an important part of the personal computer 1. The personal computer 1 shown in FIG. 2 includes an MPU 11, a ROM 12 which stores firmware, a RAM 13 which forms work area, an interface 15 with respect to the disk drive 7, and an input section 16 which are connected via a bus 17. The illustration of the input section 16 is omitted in FIG. 1, but includes a keyboard, a mouse and the like. The hardware structure itself of the personal computer 1 is known, and of course, it is possible to use other known hardware structures for the personal computer 1.

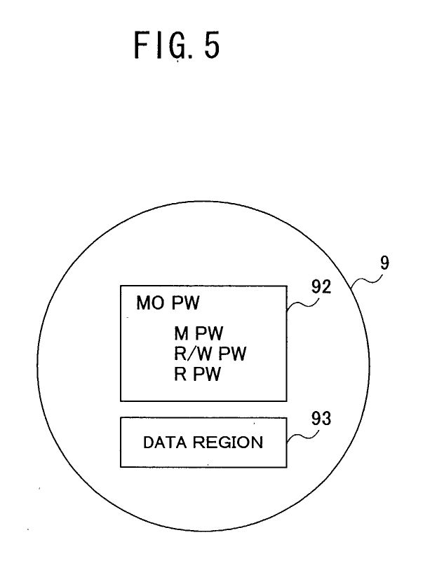

The disk drive 7 includes a disk inserting opening 8 as shown in FIG. 1. A security disk 9 is loaded into and unloaded from the disk drive 7 via the disk inserting opening 8. The disk drive 7 forms a first embodiment of the storage apparatus according to the present invention. In this embodiment, the security disk 9 is formed by a security magneto-optical (MO) disk. The security disk 9 will be described later in conjunction with FIG. 5.

The storage medium itself is not limited to a particular type of media such as the security MO disk 9, as long as an information processing apparatus such as the personal computer 1 can record information on and/or reproduce information from the storage medium. The storage medium may be selected from disk and card-shaped magnetic recording media, optical recording media and magneto-optical recording media, and semiconductor memory devices such as RAMs. Moreover, the storage medium is not limited to portable or removable storage media. Accordingly, the storage apparatus simply needs to have a structure in accordance with the kind of storage medium used, and is not limited to the disk drive 7.

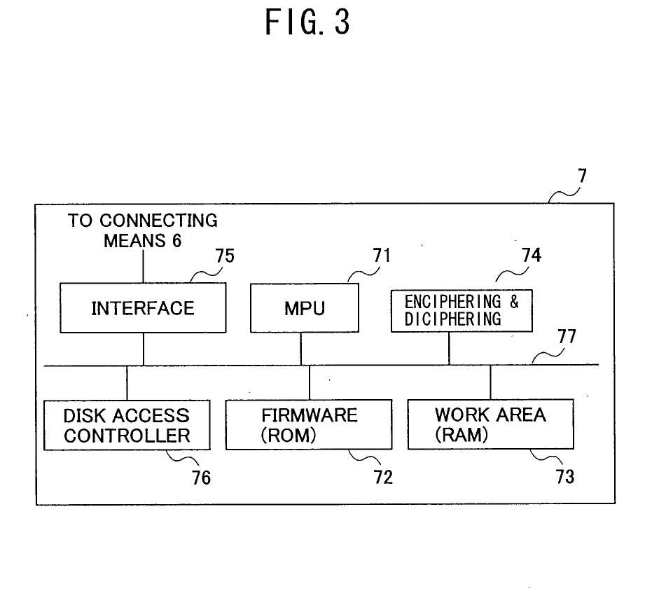

FIG. 3 is a system block diagram showing a structure of an important part of the disk drive 7. The disk drive 7 shown in FIG. 3 includes an MPU 71, a ROM 72 which stores firmware, a RAM 73 which forms work area, an enciphering and deciphering circuit 74, an interface 75 with respect to the personal computer 1 which forms a host unit, and a disk access controller 76 which are connected via a bus 77. The enciphering and deciphering circuit 74 may be omitted in this embodiment, but is used in a second embodiment which will be described later. A recording and reproducing means itself for recording information on and reproducing information from the security disk 9 is known, and thus, illustration and description thereof will be omitted. The hardware structure itself of the disk drive 7 is known, and of course, it is possible to use other known hardware structures for the disk drive 7.

FIG. 4 is a diagram showing a structure of the secure PC card 5. The secure PC card 5 shown in FIG. 4 includes SRAMs 51 and 52. The SRAMs 51 and 52 may be formed by a single SRAM. The SRAM 51 stores a password SPCPW and the like for the secure PC card 5. The SRAM 52 stores key information KEY1, KEY2, KEY3, . . . and the like related to a plurality of security disks 9 which may be used by the legitimate (or authorized) user of the secure PC card 5.

For example, when making a disk X accessible by users A and B, the same key information (for example, KEY1) is stored in a secure PC card which is usable by the users A and B. In addition, when making a disk Y accessible by users A and C, the same key information (for example, KEY2) is stored in a secure PC card which is usable by the users A and C. In this manner, common key information which is common to a group of users authorized to access the same security disk is stored in the secure PC card which is usable by each of the users belonging to this group.

In this embodiment, the present invention is applied to the PC card having the security function. However, it is of course possible to similarly apply the present invention to card devices such as IC cards, including smart cards, and to key devices which are connected via USB interfaces.

FIG. 5 is a diagram showing a structure of a storage region on the security disk 9. As shown in FIG. 5, storage regions 92 and 93 are provided on the security disk 9. The storage region 92 is provided to store a password MOPW for the security disk 9. The password MOPW for the security disk 9 is formed by at least one of a manager password MPW, a read/write password R/WPW, a read password RPW and the like. The manager password MPW is used for authenticating the manager of the security disk 9. The read/write password R/WPW is used for authenticating the read access and the write access with respect to the security disk 9. The read password RPW is used for authenticating the read access with respect to the security disk 9. The storage region 93 is provided to store data.

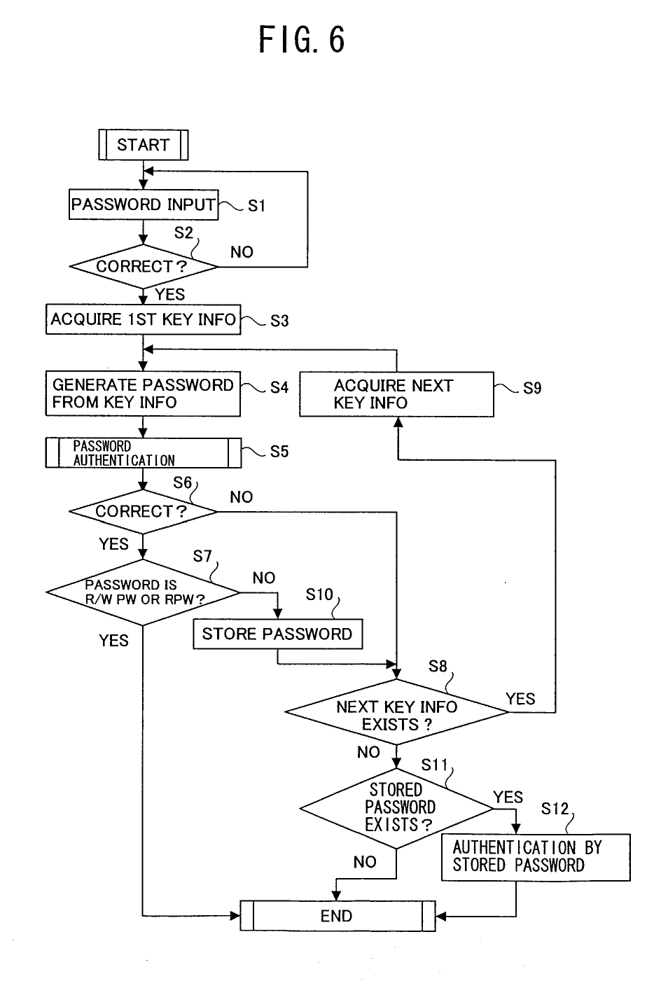

FIG. 6 is a flow chart for explaining a password authentication process. The password authentication process shown in FIG. 6 is carried out by the MPU 11 of the personal computer 2 shown in FIG. 2. For the sake of convenience, it is assumed that the secure PC card 5 is inserted into and connected to the personal computer 1, and the security disk 9 is loaded into the disk drive 7.

In FIG. 6, a step S1 urges the user to input the password SPCPW for the secure PC card 5, and the user inputs a password from the input section 16. A step S2 compares the input password and the password SPCPW read from the SRAM 51 of the secure PC card 5, and decides whether or not the input password correctly matches the password SPCPW. The process returns to the step S1 if the decision result in the step S2 is NO. On the other hand, if the decision result in the step S2 is YES, a step S3 reads and acquires first key information (for example, KEY1) from the SRAM 52 of the secure PC card 5. A step S4 generates a password for the security disk 9 based on the acquired key information. The key information may be used as it is as the password for the security disk 9. But in order to improve the security, it is desirable to generate the password for the security disk 9 by subjecting the key information to an arbitrary process. An algorithm or the like used by such an arbitrary process is not limited to a specific type.

A step S5 starts a password authentication process for the security disk 9, based on the password for the security disk 9 generated in the step S4 and the password MOPW for the security disk 9 which is read from the security disk 9 and notified from the disk drive 7. A step S6 compares the password for the security disk 9 generated in the step S4 and the password MOPW for the security disk 9 which is read from the security disk 9 and notified from the disk drive 7, and decides whether or not the generated password correctly matches the password MOPW. If the decision result in the step S6 is YES, a step S7 decides whether or not the generated password is the read/write password R/WPW or the read password RPW. The process ends if the decision result in the step S7 is YES.

If the decision result in the step S6 is NO, a step S8 decides whether or not next key information (for example, KEY2) is stored in the SRAM 52 of the secure PC card 5. If the decision result in the step S8 is YES, a step S9 reads and acquires the next key information from the SRAM 52 of the secure PC card 5, and the process returns to the step S4. If the decision result in the step S7 is NO, a step S10 stores the generated password in the RAM 13, and the process advances to the step S8.

If the decision result in the step S8 is NO, a step S11 decides whether or not there exists a password stored in the RAM 13. If the decision result in the step S11 is YES, a step S12 carries out the password authentication process for the security disk 9 based on the stored password, and the process ends. On the other hand, the process ends if the decision result in the step S11 is NO.

According to this embodiment, when the user inputs the password for the secure PC card 5 and the password authentication process confirms that the user is the legitimate user of the secure PC card 5, the password for the security disk 9 is automatically generated based on the key information stored in the secure PC card 5. The generated password for the security disk 9 is used to carry out the password authentication process for confirming that the user is the legitimate user of the security disk 9. Therefore, there is no need for the user to input the password for the security disk 9.

In this specification, the “password” is a code which is used to carry out an authentication process for confirming that the user who input the password is a legitimate user. Hence, the “password” may be a code exclusively for the authentication process or, a code which is used in common for other purposes, such as a user ID.

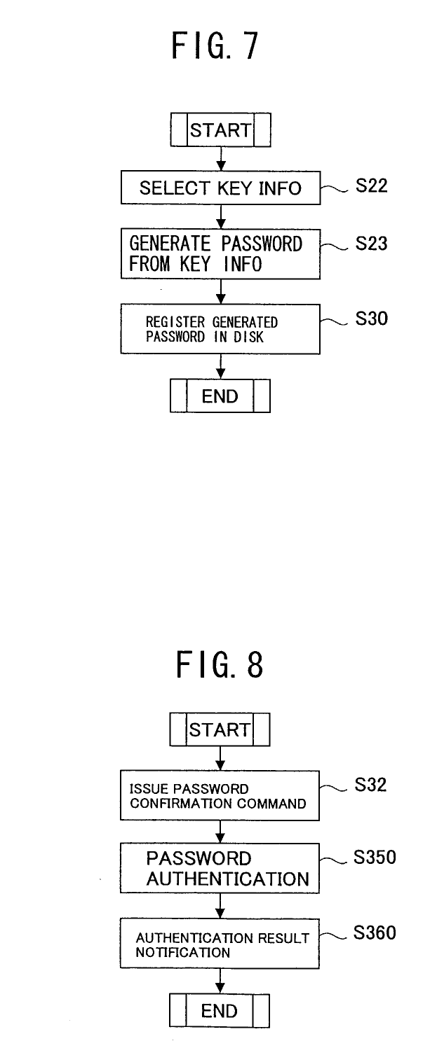

Next, a description will be given of a password setting process for the security disk 9, which sets the password MOPW for the security disk 9, by referring to FIG. 7. FIG. 7 is a flow chart for explaining the password setting process for the disk. The password setting process shown in FIG. 7 is carried out by the MPU 11 of the personal computer 1 shown in FIG. 2, with respect to a security disk 9 which is not yet set with the password therefor.

In FIG. 7, a step S22 selects key information to be used when the user accesses the security disk 9 which is loaded into the disk drive 7. In this case, the key information may be displayed as it is on the display 2 of the personal computer 1 or, a corresponding character string or the like may be displayed in a 1:1 relationship to the key information. In the latter case, the corresponding key information can be read from the secure PC card 5 by specifying the character string or the like. Thus, this latter case can improve the security from the point of view of making the key information not directly visible to the user. A step S23 generates the password for the security disk 9 based on the key information (for example, KEY1) which is selected in the step S22. A step S30 records the generated password for the security disk 9, as the password MOPW, in the storage region 92 of the security disk 9, and the process ends.

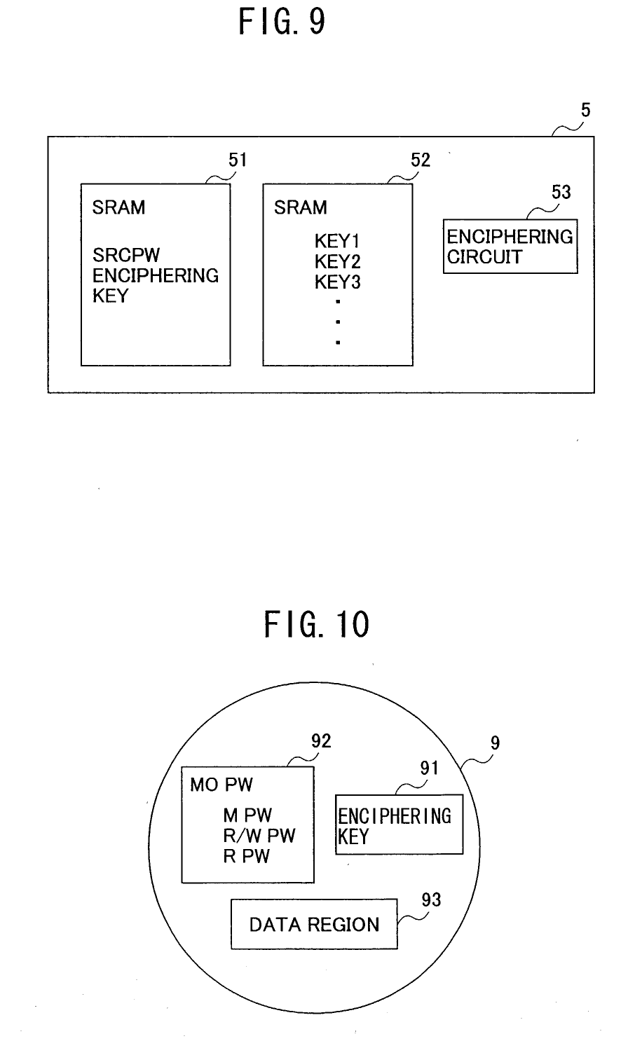

FIG. 8 is a flow chart for explaining a password authentication process for the security disk 9. The password authentication process shown in FIG. 9 corresponds to the process of the step S5 shown in FIG. 6, and is carried out by the MPU 11 of the personal computer 1 shown in FIG. 2.

In FIG. 8, a step S32 issues a password confirmation command with respect to the disk drive 7. A step S350 compares the generated password for the security disk 9 and the password MOPW for the security disk 9 read from the storage region 92 of the security disk 9, and judges whether the generated password correctly matches the password MOPW. If the compared passwords match, it is confirmed that the user is the legitimate user of the security disk 9. A step S360 notifies an authentication result obtained in the step S350 to the MPU 11, and the process ends.

Next, a description will be given of a second embodiment of the access control method, the storage apparatus and the information processing apparatus according to the present invention. This second embodiment uses the personal computer 1 and the disk drive 7 having the same hardware structures as those of the first embodiment, and illustration and description thereof will be omitted. In addition, the disk drive 7 is provided with the enciphering and deciphering circuit 74 in this second embodiment. When the personal computer 1 transfers the password for the security disk 9 to the disk drive 7, this second embodiment enciphers the password and transfers the enciphered password. Accordingly, in the process shown in FIG. 6, the process of the step S5 is carried out by the MPU 11 of the personal computer 1 and the MPU 71 of the disk drive 7.

FIG. 9 is a diagram showing a structure of the secure PC card 5 used in this second embodiment. In FIG. 9, those parts which are the same as those corresponding parts in FIG. 4 are designated by the same reference numerals, and a description thereof will be omitted. As shown in FIG. 9, the secure PC card 5 includes the SRAM 51, the SRAM 52 and an enciphering circuit 53. The enciphering circuit 53 is provided to encipher the password MOPW for the security disk 9, as will be described later.

FIG. 10 is a diagram showing a structure of a memory region on the security disk 9 which is used in this second embodiment. In FIG. 10, those parts which are the same as those corresponding parts in FIG. 5 are designated by the same reference numerals, and a description thereof will be omitted. As shown in FIG. 10, storage regions 91 through 93 are provided on the security disk 9. As will be described later, the storage region 91 is provided to store an enciphering key and the like stored in the SRAM 51 of the secure PC card 5.

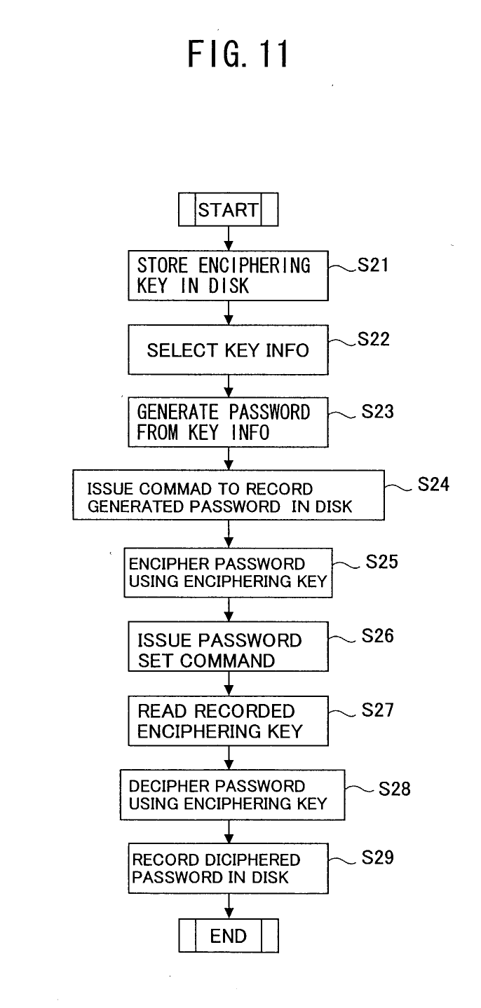

Next, a description will be given of a password setting process for the security disk 9, which sets the password MOPW for the security disk 9, by referring to FIG. 11. FIG. 11 is a flow chart for explaining the password setting process for the disk. In FIG. 11, those steps which are the same as those corresponding steps in FIG. 7 are designated by the same reference numerals, and a description thereof will be omitted. The password setting process is carried out by the MPU 11 of the personal computer 1 shown in FIG. 2 and the MPU 71 of the disk drive 7 shown in FIG. 3, with respect to a security disk 9 which is not yet set with the password therefor. In FIG. 11, processes of steps S21 through S26 are carried out by the MPU 11 of the personal computer 1, and processes of steps S27 through S29 are carried out by the MPU 71 of the disk drive 7.

In FIG. 11, the step S21 reads an enciphering key from the SRAM 51 of the secure PC card 5, and supplies the enciphering key to the disk drive 7 so as to record the enciphering key in the storage region 91 of the security disk 9. The step S22 selects key information to be used when the user accesses the security disk 9 which is loaded into the disk drive 7. In this case, the key information may be displayed as it is on the display 2 of the personal computer 1 or, a corresponding character string or the like may be displayed in a 1:1 relationship to the key information. In the latter case, the corresponding key information can be read from the secure PC card 5 by specifying the character string or the like. Thus, this latter case can improve the security from the point of view of making the key information not directly visible to the user.

The step S23 generates the password for the security disk 9 based on the key information (for example, KEY1) which is selected in the step S22. The step S24 issues, with respect to the disk drive 7, a register command for recording the generated password for the security disk 9 on the security disk 9. The step S25 enciphers the password for the security disk 9, using the enciphering key which is read from the SRAM 51 of the secure PC card 5. The step S26 issues, with respect to the disk drive 7, a password set command and a flag which indicates that the password for the security disk 9 is enciphered.

The step S27 reads the enciphering key which is recorded in the storage region 91 of the security disk 9. The step S28 deciphers the enciphered password for the security disk 9 by the enciphering and deciphering circuit 73, using the enciphering key read in the step S27. In addition, the step S29 records the deciphered password for the security disk 9, as the password MOPW, in the storage region 92 of the security disk 9, and the process ends.

In the process shown in FIG. 11, when transferring the password for the security disk 9 from the personal computer 1 to the disk drive 7, the password is transferred in the enciphered state. For this reason, the security can be improved. If there is no problem of security, it is of course possible to transfer the password for the security disk 9 from the personal computer 1 to the disk drive 7, as it is, as in the case of the first embodiment described above.

According to this second embodiment, the password for the security disk 9 is enciphered when transferring the password from the personal computer 1 to the disk drive 7. Consequently, the process of the step S5 shown in FIG. 6 is carried out by the MPU 11 of the personal computer 1 and the MPU 71 of the disk drive 7.

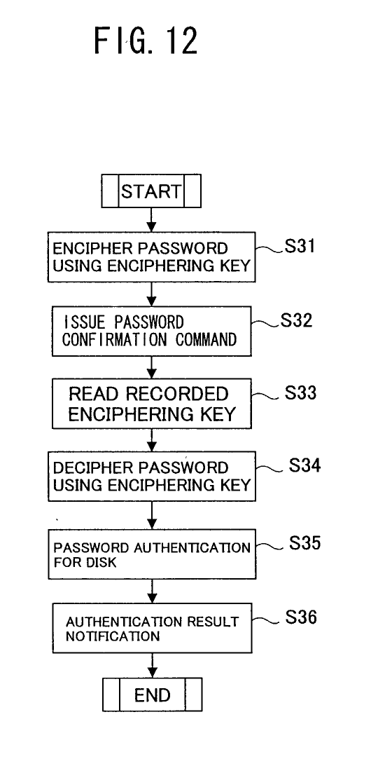

FIG. 12 is a flow chart for explaining a password authentication process with respect to the password for the security disk 9 in this second embodiment. The password authentication process shown in FIG. 12 corresponds to the process of the step S5 shown in FIG. 6, and is carried out by the MPU 11 of the personal computer 1 shown in FIG. 2 and the MPU 71 of the disk drive 7 shown in FIG. 3. In FIG. 12, those steps which are the same as those corresponding steps in FIG. 8 are designated by the same reference numerals, and a description thereof will be omitted. In FIG. 12, processes of steps S31 and S32 are carried out by the MPU 11 of the personal computer 1, and processes of steps S33 through S36 are carried out by the MPU 71 of the disk drive 7.

In FIG. 12, the step S31 enciphers the password for the security disk 9 generated by the step S4 shown in FIG. 6, using the enciphering key which is read from the SRAM 51 of the secure PC card 5. The step S32 issues, with respect to the disk drive 7, a password confirmation command and a flag which indicates that the password for the security disk 9 is enciphered.

The step S33 reads the enciphering key which is recorded in the storage region 91 of the security disk 9. The step S34 deciphers by the enciphering and deciphering circuit 73 the enciphered password for the security disk 9, which is transferred from the personal computer 1, using the enciphering key read in the step S33. The step S35 compares the deciphered password for the security disk 9 and the password MOPW for the security disk 9 read from the storage region 92 of the security disk 9, and decides whether or not the deciphered password correctly matches the password MOPW. If the compared passwords match, it is confirmed that the user is a legitimate user of the security disk 9. The step S36 notifies the authentication result obtained in the step S35 to the personal computer 1, and the process ends. Accordingly, the step S6 shown in FIG. 6 can judge whether or not the generated password is correct, based on the authentication result notified from the disk drive 7.

The personal computer 1 may be a desk-top computer or a lap-top (or portable) computer. In addition, the information processing apparatus is not limited to the personal computer 1. The information processing apparatus may be formed by a portable terminal equipment such as a portable telephone set, a digital camera for taking still pictures and/or moving pictures, an intelligent television apparatus or the like.

Moreover, it is not essential for the disk drive 7 to be connected externally to the main body 3 of the personal computer 1, and the disk drive 7 may be provided within the main body 3 or the like to form a part of the personal computer 1.

Further, the present invention is not limited to these embodiments, but various variations and modifications may be made without departing from the scope of the present invention.

What is claimed is:

1. An access control method for controlling access from an information processing apparatus which is connectable to a device requiring a first password authentication to a storage medium which requires a second password authentication, comprising:
a password generating step which automatically generates a password based on key information read from the device, when an authentication result of a password input to the information processing apparatus and a first password read from the device is correct; and
an access control step which enables access to the storage medium when an authentication result of the generated password and a second password read from the storage medium is correct.

2. The access control method as claimed in claim 1, wherein key information common to a group of users authorized to access the same storage medium is stored in the device which is accessible by each of the users belonging to the group.

3. The access control method as claimed in claim 1, wherein:
the storage medium is loaded into a storage apparatus which is connectable to the information processing apparatus;
said access control method further comprises:
an enciphering step which enciphers the generated password within the information processing apparatus based on an enciphering key read from the device, and transfers the enciphered password to the storage apparatus; and
said access control step deciphers the enciphered password based on an enciphering key read from the storage medium, and enables access to the storage medium when an authentication result of the deciphered password and the second password read from the storage medium is correct within the storage apparatus.

4. The access control method as claimed in claim 3, further comprising:
a first recording step which transfers the enciphering key from the information processing apparatus to the storage apparatus and records the enciphering key in the storage medium; and
a second recording step which deciphers the enciphered password transferred by said enciphering step into the second password within the storage apparatus, based on the enciphering key reproduced from the storage medium, and records the second password in the storage medium,
said first and second recording steps being carried out when setting the second password with respect to the storage medium.

5. A storage apparatus loadable with a storage medium which is accessible from an information processing apparatus which is connectable to a device requiring a first password authentication, said storage medium requiring a second password authentication, said storage apparatus comprising:
a receiving section which receives from the information processing apparatus a password which is generated when an authentication result of a password input to the information processing apparatus and the first password read from the device is correct, and is enciphered using an enciphering key which is generated based on key information from the device and read from the device; and
an access control section which enables access from the information processing apparatus to the storage medium when an authentication result of the enciphered password which is deciphered based on an enciphering key read from the storage medium and the second password read from the storage medium is correct.

6. The storage apparatus as claimed in claim 5, wherein key information common to a group of users authorized to access the same storage medium is stored in the device which is accessible by each of the users belonging to the group.

7. An information processing apparatus which is connectable to a device requiring a first password authentication and accesses a storage medium requiring a second password authentication, comprising:
a password generating section which automatically generates a password based on key information read from the device, when an authentication result of an input password and a first password read from the device is correct; and
an access control section which enables access to the storage medium when an authentication result of the generated password and a second password read from the storage medium is correct.

8. The information processing apparatus as claimed in claim 7, wherein key information common to a group of users authorized to access the same storage medium is stored in the device which is accessible by each of the users belonging to the group.

9. The information processing apparatus as claimed in claim 7, wherein:
the storage medium is loaded into a storage apparatus which is connectable to the information processing apparatus;
said information processing apparatus further comprises:
an enciphering section which enciphers the generated password based on an enciphering key read from the device, and transfers the enciphered password to the storage apparatus; and
said access control section deciphers the enciphered password based on an enciphering key read from the storage medium, and enables access to the storage medium when an authentication result of the deciphered password and the second password read from the storage medium is correct within the storage apparatus.

10. The information processing apparatus as claimed in claim 9, further comprising:
a first recording section which transfers the enciphering key from the information processing apparatus to the storage apparatus and records the enciphering key in the storage medium; and
a second recording section which deciphers the enciphered password transferred by said enciphering section into the second password within the storage apparatus, based on the enciphering key reproduced from the storage medium, and records the second password in the storage medium,
said first and second recording sections carrying recording operations when setting the second password with respect to the storage medium.
